(19) United States
(12) Patent Application Publication
(10) Pub. No.: US 2010/0051364 A1
(43) Pub. Date: Mar. 4, 2010

(54) APPARATUS FOR ASSISTING MOTION OF VEHICLES

(76) Inventor: Yadon ARAD, Mountain View, CA (US)

Correspondence Address: PERKINS COIE LLP, P.O. BOX 1208, SEATTLE, WA, 98111-1208, US

(21) Appl. No.: 12/208,291

(22) Filed: Sep. 10, 2008

Related U.S. Application Data
(60) Provisional application No. 61/092,711, filed on Aug. 28, 2008.

(51) Int. Cl. B60K 6/00

(52) U.S. Cl. 180/65.31

(57) ABSTRACT

Apparatuses for assisting motion of vehicles are disclosed here. Embodiments of the present disclosure include an apparatus comprising, a charge-storage unit, an electromotor coupled to the charge-storage unit, wherein, at least a portion of the power supplied to the electromotor is supplied by the charge-storage unit. The apparatus may further include, a movable portion powered by the electromotor, a housing coupled to the electromotor, and a handle coupled to the housing, the handle being physically configured to, when, in operation, couple to an external entity to whom motion assistance is to be provided. The external entity may be a vehicle although other objects may be used.

### CROSS REFERENCE TO RELATED APPLICATION

This application claims priority to U.S. Provisional Patent Application Ser. No.: 61/092,711 filed Aug. 28, 2008, entitled “A Power Module for Assisting Motion of Vehicles” by Yadon Arad, Attorney Docket No. 69158-8001.US00, which application is hereby incorporated by reference.

### FIELD OF TECHNOLOGY

The technology generally relates to decreasing the environmental impacts of vehicles. More specifically, it relates to an apparatus that can use electrical motors to assist the motion of vehicles to improve environmental friendliness.

### BACKGROUND

Vehicles based on internal-combustion-engines are ubiquitous in present day transportation. However, the same engines are culprits of a large percentage of the increased carbon-dioxide emissions and the increasing green-house effect. The limited supply of oil and natural gas, and world politics have resulted in increased price of oil and natural gas placing a severe financial burden on the average citizen of the planet.

The vehicle industry based on internal-combustion engines has been mature and is capable of manufacturing low cost vehicles, whereas vehicles based on electricity and other energy sources have not yet become conveniently available to the average person on the planet. Furthermore, there are millions of inefficient cars that are already in use and those cars will remain inefficient and will use oil for fuel until the owners manage to afford new fuel-efficient vehicles based on alternative energy sources.

### BRIEF DESCRIPTION OF THE DRAWINGS

FIG. 1 illustrates a diagrammatic view of a system of a composite vehicle having vehicle coupled to an apparatus that assists motion of the vehicle, according to one embodiment.

FIG. 2 depicts an example block diagram the apparatus for motion assistance, in accordance with embodiments of the present disclosure.

FIG. 3 illustrates another diagrammatic view of a vehicle coupled to an apparatus that is equipped with a power cable, according to one embodiment

FIG. 4 depicts a flow chart illustrating an example process for assisting the motion of vehicles, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

As an alternative to oil and natural gas, electrical energy can be obtained from various renewable sources including but not limited to: wind, sun, geothermal sources. It can also be obtained from hydroelectric power plans which do not emit carbon-dioxide.

Embodiments of the present disclosure include a method and apparatus that uses electrical energy to move a vehicle that otherwise uses an internal-combustion-engine. The electrical energy can be obtained from various sources including renewable sources to reduce fuel usage and to reduce carbon dioxide and/or other harmful emissions.

In one embodiment, an apparatus is coupled to a vehicle and provides at least a part of the force used to move the vehicle. The apparatus may be coupled to any part of the vehicle although generally to the rear.

In one embodiment, the apparatus includes, a wheel, an electromotor, an energy-storage device, and/or a handle operatively configured to couple the apparatus to the vehicle for motion assistance.

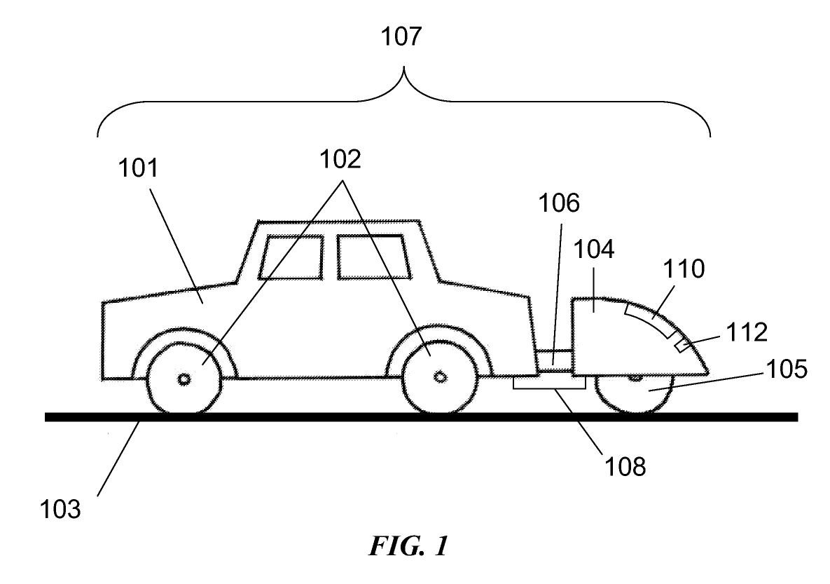

FIG. 1 illustrates a diagrammatic view of a system of a composite vehicle 107 having vehicle 101 coupled to an apparatus 104 that assists motion of the vehicle 101, according to one embodiment.

The vehicle 101 is typically powered by internal-combustion and/or any other means including but not limited to, solar, electrical, and any combination of the above. The vehicle 101 typically has wheels 102 and is configured to move on a road 103. The apparatus 104 for assisting the motion of (e.g., assist acceleration or deceleration) the vehicle 101 can be coupled to the vehicle 101, for example, using a handle 106. The handle 106 may be implemented via any known or convenient manner, including but not limited to, a hook means, a magnetic means, a latch means, a lock means, etc.

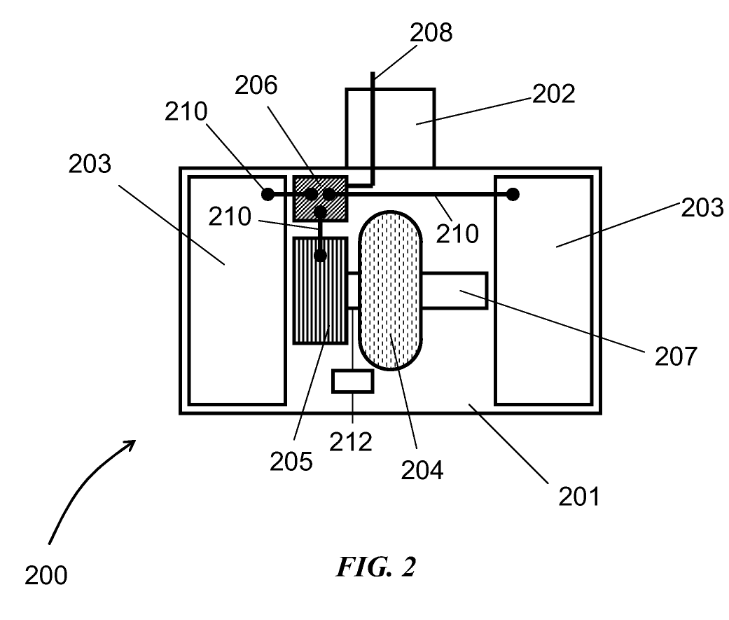

In one embodiment, the apparatus 104 comprises a wheel 105, an electromotor (illustrated with further reference in the example of FIG. 2), and/or an energy-storage unit (also illustrated with further reference to the example of FIG. 2). In some embodiments, the apparatus 104 may have two or more wheels as suitable for the vehicle 101 or for the particular conditions of the road 103.

The electromotor typically facilitates the movement of the vehicle 101 and the energy-storage unit can provide the energy/power required to do so. The energy-storage unit can also recharge based on internal energy generation means or via coupling to external sources. One embodiment includes a communication bus 108 though which the vehicle 101 and the apparatus 104 communicate.

Furthermore, the apparatus 104 may include a display or screen 110 visible from external entities such as pedestrians or other cars driving on the road 103. The display or screen 110 may be used to display images and/or videos including but not limited to banners, advertisements or other promotional content, movies, pictures, and the like. The apparatus 104 may also include lighting 112 as brake lights and/or turning lights.

As the vehicle 101 moves on the road 103 using fossil fuel, the apparatus 104 uses electrical energy. For example,

In one embodiment, the movement of the composite vehicle 107 is powered partially or wholly by the apparatus 104.

FIG. 2 depicts an example block diagram the apparatus 200 for motion assistance, in accordance with embodiments of the present disclosure.

One embodiment of the apparatus 200 includes a wheel 204, an electromotor module 205, an energy storage unit 203, and/or a housing 201. Additional or less components may be included without deviating from the novel art of the disclosure. It is appreciated that some components may be partially or wholly integrated with one or more of the other components although the functions represented therein may be similar and are considered to be within the novel art of the disclosure.

One embodiment further includes a shaft apparatus 207, around which the wheel 204 can rotate. The wheel 204 is configured to rotate around the shaft apparatus 207 and relative to the housing 201. Additional wheels 204 and shaft apparatuses 207 may be included and is considered to be within the novel art of the disclosure.

In one embodiment, the electromotor 205 converts electrical power to mechanical power. In alternate embodiments, the electromotor 205 can be any device or module that is able to convert electrical power or any other type of power to mechanical power. Since the electromotor module 205 is coupled to the shaft apparatus 207, the wheel or set of wheels 204 can rotate (or be accelerated) when the electromotor module 205 is in operation. The electromotor module 205 and/or the shaft apparatus 207 may further be mechanically coupled to the housing 201.

In one embodiment, the apparatus 200 includes a handle 202. The handle 202 can be configured to couple the housing 201 to a vehicle to which motion assistance is provided. The vehicle may be powered by internal combustion or other means, or a combination of means.

One embodiment includes optionally, a controller module 206 which can communicate with the vehicle via a communication bus 208. The controller module 206 can control the power flow between the energy-storage unit 203 and the electromotor module 205, for example, via power lines 210. The controller module 206 may be preprogrammed with a predetermine set of settings that determine the amount of energy to be stored in the energy-storage unit 203. In addition, the controller module 206 may be reconfigurable by a user (e.g., vehicle driver) or may be adaptable to usage conditions, environmental conditions in real-time or near real-time.

The communication bus 208 can be used to manage communications between the vehicle (e.g., the vehicle of the example in FIG. 1) and the apparatus 200. The information communicated between the vehicle and the apparatus 200 can include by way of example but not limitation, driving information, road conditions, gas mileage, gas level, rpm, wind strength, average speed, gear settings, gear shift, acceleration, deceleration, braking, cruising, etc. This information can be used by the apparatus 200 to determine the power and speed provided by the electromotor module 205 to assist the motion of the coupled vehicle. Although a wired bus is illustrated in FIG. 1-2, in some embodiments, the vehicle and the apparatus 200 may communicate wirelessly.

One embodiment of the apparatus 200 includes a gear 212 coupled to the wheel 204. In one embodiment, the apparatus 200 is used to accelerate the vehicle by pushing the vehicle. This can occur when the electromotor module 205 is powered by electricity (e.g., the electricity stored in the energy-storage unit 203) or by electricity obtained elsewhere.

In another embodiment, the apparatus 200 is used to slow down the vehicle and charge the energy-storage unit 203 during deceleration.

Note that although embodiments in the present example are described with specific reference to motion assistance in vehicles, it is appreciated the apparatus 200 can be used for motion assistance of other objects and entities, for similar or dissimilar purposes, without deviating from the scope of the disclosure.

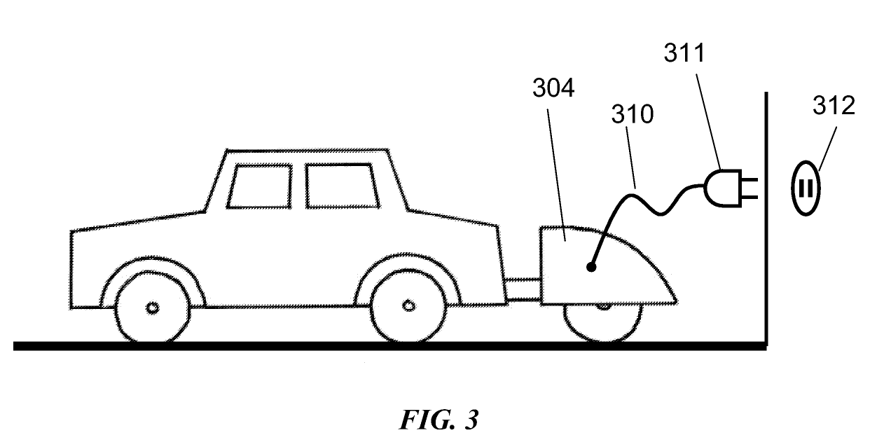

FIG. 3 illustrates another diagrammatic view of a vehicle coupled to an apparatus 304 that is equipped with a power cable 310, according to one embodiment

In one embodiment, the apparatus 304 is further equipped with a power cable 310. The power cable can be used to replenish the charge or energy stored in the energy-storage unit (e.g., the energy storage unit 203 in the example of FIG. 2) in the apparatus 304 by plugging the power cable 310 into a power outlet 312.

The power plug 311 can be inserted into a power output such as a power outlet 312, common to many households and industry as a source of electrical power. It may also be plugged into a 220 Volt power outlet or to more sophisticate charging apparatuses which allows charging in as little as ten minutes. When the power plug 311 is inserted into the power outlet 312 (the receptacle 312) the energy-storage unit in the power module 304 is being charged.

In another embodiment, the apparatus 304 includes at least one solar cell. The solar cell can be used to obtain and energy from solar sources. In one embodiment, the solar cell is coupled to the energy-storage unit of the apparatus 304 to provide some or most of the energy to replenish the energy-storage unit.

In yet another embodiment, the vehicle coupled to the apparatus 304 includes at least one solar cell, the solar cell providing energy to replenish the energy-storage unit in the apparatus 304.

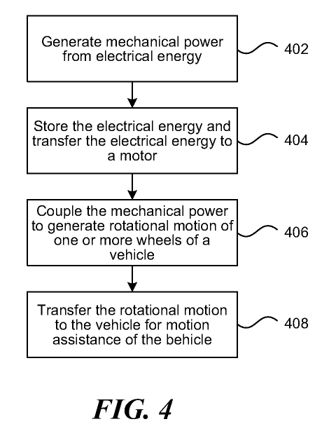

FIG. 4 depicts a flow chart illustrating an example process for assisting the motion of vehicles, according to one embodiment.

In process 402, mechanical power is generated from electrical energy. In process 404, the electrical energy is stored and transferred to a motor. In process 406, the mechanical power is coupled to generate rotational motion of the wheels of a vehicle. In process 408, the rotational motion is transferred to the vehicle for motion assistance of the vehicle.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. An apparatus, comprising:
a charge-storage unit;
an electromotor coupled to the charge-storage unit;
wherein, at least a portion of the power supplied to the electromotor is supplied by the charge-storage unit;
a movable portion powered by the electromotor;
a housing coupled to the electromotor; and
a handle coupled to the housing, the handle being physically configured to, when, in operation, couple to an external entity to whom motion assistance is to be provided.

2. The apparatus of claim 1, wherein the movable portion comprises one or more wheels that are capable or rotational motion.

3. The apparatus of claim 2, wherein, the external entity is a vehicle.

4. The apparatus of claim 3, wherein the vehicle employs an internal-combustion engine.

5. The apparatus of claim 1, further comprising, a controller module, coupled to the electromotor and the charge-storage unit to control energy and power flow; wherein the controller module is one or more of, preprogrammed, configurable, and re-configurable.

6. The apparatus of claim 1, wherein, the electromotor is coupled to the movable portion via a shaft to which one or more wheels are coupled to.

7. The apparatus of claim 1, further comprising, a communication bus.

8. The apparatus of claim 1, wherein the charge-storage unit is coupled to a solar cell.

9. The apparatus of claim 1, further comprising a power cable suitable for being plugged into a power outlet.

10. The apparatus of claim 6, wherein energy obtained from the power cable is stored in the charge-storage unit.

11. A system of a motion-assisted vehicle, comprising:
a charge-storage unit;
an electromotor coupled to the charge-storage unit;
wherein, at least a portion of the power supplied to the electromotor is supplied by the charge-storage unit;
a movable portion powered by the electromotor;
a housing coupled to the electromotor;
a handle coupled to the housing; and
a motion-assisted vehicle on a road coupled to the handle.

12. The system of claim 8, wherein the vehicle employs an internal-combustion engine.

13. The system of claim 8, wherein the movable portion comprises one or more wheels that are capable or rotational motion on the road.

14. The system of claim 8, wherein the charge-storage unit is coupled to a solar cell.

15. The apparatus of claim 1, further comprising, a controller module, coupled to the electromotor and the charge-storage unit to control energy and power flow; wherein the controller module is one or more of, preprogrammed, configurable, and re-configurable.

16. The apparatus of claim 1, wherein, the electromotor is coupled to the movable portion via a shaft.

17. A method for providing environmentally friendly transportation, the method, comprising:
generating mechanical power from electrical energy;
coupling the mechanical power to generate rotational motion of one or more wheels of a vehicle;
transferring the rotational motion to a vehicle for motion assistance of the vehicle.

18. The method of claim 17, further comprising, storing electrical energy and transferring the electrical energy to a motor.

19. The method of claim 17, further comprising, generating or obtaining the electrical energy for storage.

20. The method of claim 17, wherein, the motion assistance comprise assistance in acceleration or deceleration of the vehicle.
